(19) United States
(12) Patent Application Publication
(10) Pub. No.: US 2011/0239226 A1
(43) Pub. Date: Sep. 29, 2011

(54) CONTROLLING CONGESTION IN MESSAGE-ORIENTED MIDDLEWARE

(76) Inventor: Cesare Placanica, Milan (IT)

(21) Appl. No.: 12/729,753

(22) Filed: Mar. 23, 2010

(51) Int. Cl. G06F 9/54

(52) U.S. Cl. 719/313

(57) ABSTRACT

A method is disclosed for controlling congestion in message oriented middleware. In an embodiment, the round trip time for transmitting messages through a message oriented middleware server may be estimated. Further, the frequency that messages are transmitted to the server may be adjusted based on the estimated round trip time in order to reduce congestion at the server.

### TECHNICAL FIELD

The present disclosure generally relates to client-server message communication techniques.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

In client-server application development, Message Oriented Middleware (MOM) may provide an application-level infrastructure to exchange messages between client-server applications. MOM may be structured such that a MOM server or broker is positioned between a client and a server; examples include Common Object Request Broker Architecture (CORBA) implementations from TIBCO, Inc. The client and the server may communicate with each other by using the MOM broker's API to communicate messages to and from the broker. The MOM broker may allow the client and server to communicate asynchronously. For example, a Message Queuing Middleware (MQM) broker may store messages sent by a message producer in a queue to be retrieved later by a message consumer. Thus, the broker may facilitate communication between client and server in a reliable and efficient manner without requiring the client and server to communicate directly.

In some circumstances, message congestion may occur in MOM, for example, during network node discovery, cable cuts, LAN disconnections and alarm storms. The network nodes, or the application components controlling the nodes, may send a large number of messages that other components should consume. However, message consumers may be unable to consume the large number of messages at a fast enough rate. MOM brokers may store messages in memory or on disk until the consumer can retrieve the messages or the MOM brokers may simply drop messages. Accordingly, MOM broker queues may reach saturation and, as a result, the MOM may experience congestion and become slow and unstable.

Certain MOM implementations provide for status messages that inform message producers of the state of the message queues within the message broker. For example, when a message producer sends a message to a message broker, the message broker may respond with an acknowledgment message informing the message producer that the broker's queues are n % full. The message producer may be configured to reduce the rate at which messages are sent to the message broker based on the queue status sent in the acknowledgement message. Thus, the message broker may control congestion by sending status messages which may cause message producers to send fewer messages.

### BRIEF DESCRIPTION OF THE DRAWINGS

In the drawings:

FIG. 1 illustrates a computer system that may be used to provide congestion control for Message Oriented Middleware;

FIG. 2 illustrates an example process for congestion control;

FIG. 3 illustrates average round trip time estimation using a Kalman filter;

FIG. 4 illustrates a computer system upon which an embodiment may be implemented.

### DETAILED DESCRIPTION

Congestion control for message-oriented middleware is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Example Congestion Control Approach
   3.1 Sending Messages
   3.2 Determining Round Trip Time
   3.3 Estimating Average Round Trip Time
   3.4 Adjusting Message Frequency
4.0 Implementation Mechanisms—Hardware Overview
5.0 Extensions and Alternatives

1.0 General Overview

In an embodiment, a computer-implemented method may include sending a first plurality of messages to a server according to a message frequency value, receiving a second plurality of messages from the server, the second plurality of messages being a subset of the first plurality of messages, determining an average round trip time (RTT) for communicating the second plurality of messages from a message producer to the server and back to the producer, and adjusting the message frequency value based on the average round trip time.

In an embodiment, the method may also include storing a timestamp representing a time that a message is sent to the server, storing a timestamp that the message is received from the server, and determining the round trip time of the message based on the time that the message was sent and the time that the message was received. In some embodiments, the server may be a message oriented middleware broker or message queuing middleware broker. In an embodiment, the average round trip time may be estimated with a change detection filter, such as a cumulative-sum Kalman adaptive filter.

In other embodiments, a computer apparatus and a computer-readable medium may be configured to carry out the foregoing steps.

2.0 Structural and Functional Overview

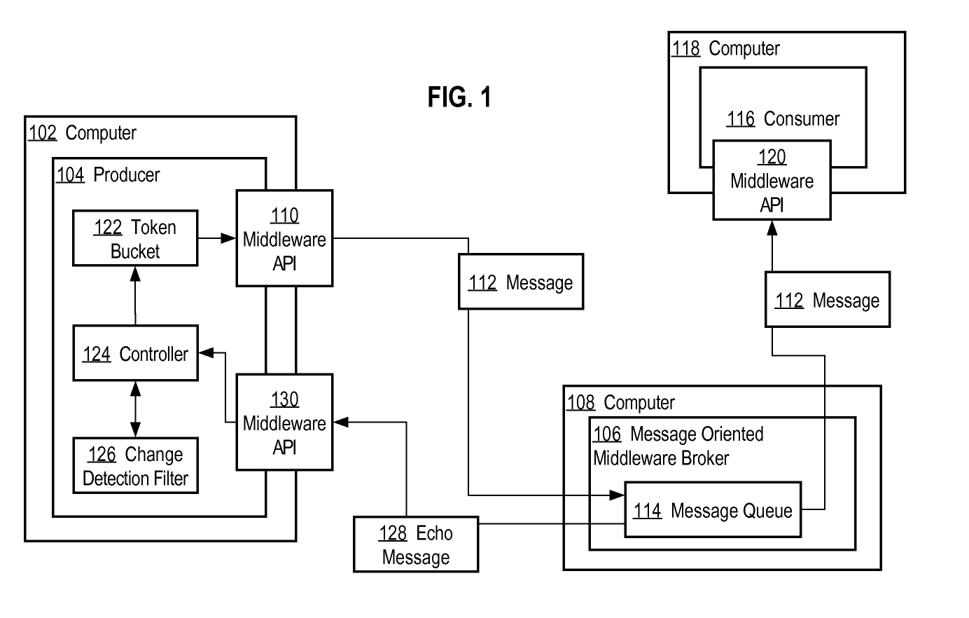

FIG. 1 illustrates a computer system that may be used to provide congestion control for MOM, according to some embodiments. A computer 102 may host a message producer 104. Message producer 104 may be, for example, one or more computer program applications, other software elements, or other functional logic utilizing the MOM to send messages to a message oriented middleware broker 106. The messages may be consumed by a consumer, for example message consumer 116. In various embodiments, consumer 116 comprises one or more computer program applications, other software elements, or other functional logic. The message producer 104 and broker 106 may comprise a client and server, respectively, or the converse. Similarly, computer 102 and computer 118 may comprise a server and client, respectively, or the converse.

In one particular embodiment, producer 104 comprises Cisco Transport Manager, from Cisco Systems, Inc., San Jose, Calif., and message oriented middleware broker 106 comprises a Java Management Object and Configuration Object (JMOCO) engine. In other embodiments, the TIBCO message broker or open-source message brokers may be used in connection with any other client-server applications.

In some embodiments, producer 104 may also be a message consumer. The message producer 104 may be communicatively coupled to message oriented middleware broker 106 on computer 108. For example, the message producer 104 may use the middleware API 110 to send message 112 to the message broker 106. When message broker 106 receives message 112 from producer 104, message broker 106 may place message 112 on message queue 114.

The message broker 106 may also be communicatively coupled to message consumer 116 on computer 118 through middleware API 120. For example, when message producer 104 sends a message 112 to broker 106, broker 106 may place message 112 on message queue 114. Once message 112 is placed on message queue 114, consumer 116 may retrieve message 112 from message queue 114 and process the message. Thus, the message broker 106 may facilitate communicating message 112 from the producer 104 to the consumer 116.

In an embodiment, producer 104 comprises a token bucket 122, controller 124, and change detection filter 126 for performing congestion control. Each of the token bucket 122, controller 124, and change detection filter 126 may be implemented using any of one or more computer programs, other software elements, computer logic, or a combination. Token bucket 122 may be configured to send messages from producer 104 to middleware API 110 according to a message frequency value. Middleware API 110 may send the messages to broker 106, as described above. Thus, producer 104 may be configured to use token bucket 122 as a conduit for all messages that the producer sends to the consumer 116, rather than the producer directly calling the middleware API 110 to send messages.

In an embodiment, controller 124 may be configured place an echo message into token bucket 122 for transmission to broker 106 in the same manner as shown for message 112 of FIG. 1. Upon receipt, broker 106 enqueues the echo message 128 to message queue 114. In an embodiment, controller 124 may be a registered consumer of echo messages 128, so that when echo message 128 is placed on message queue 114 by broker 106, controller 124 may receive and consume echo message 128. For example, controller 124 may consume echo message 128 from broker 106 through middleware API 130. Once controller 124 receives echo message 128, the controller may calculate a round trip time of echo message 128 from producer 104 to broker 106, through the message queue 114 and back to producer 104.

In an embodiment, the calculated round trip time of echo message 128 may be sent to change detection filter 126 to estimate an average round trip time for all echo messages 128 that have been sent to broker 106. In some embodiments, the change detection filter 126 may be implemented as a cumulative-sum Kalman adaptive filter which may estimate the round trip time of echo message 128. Once change detection filter 126 determines the average round trip time for echo messages, controller 124 may adjust the message frequency value in token bucket 122 based on the estimated average round trip time.

While FIG. 1 illustrates a computer system comprising message producer 104, message broker 106 and message consumer 116 each hosted on a different computer, embodiments described herein may include different configurations. For example, producer 104, broker 106 and consumer 116 may all be hosted on the same computer, according to embodiments. Moreover, producer 104 and broker 106 may reside on one computer while consumer 116 is hosted on a different computer. Alternatively, producer 104 and consumer 116 may be hosted by one computer while broker 106 is hosted on another computer. When two or more computers are used, the computers may be coupled or linked using network infrastructure such as one or more routers, switches, other infrastructure elements, LANs, WANs, or internetworks. The hosting arrangements illustrated and described in this disclosure are examples and should not be considered limiting producer 104, broker 106 and consumer 116 to any combination of computers.

3.0 Example Congestion Control Approach

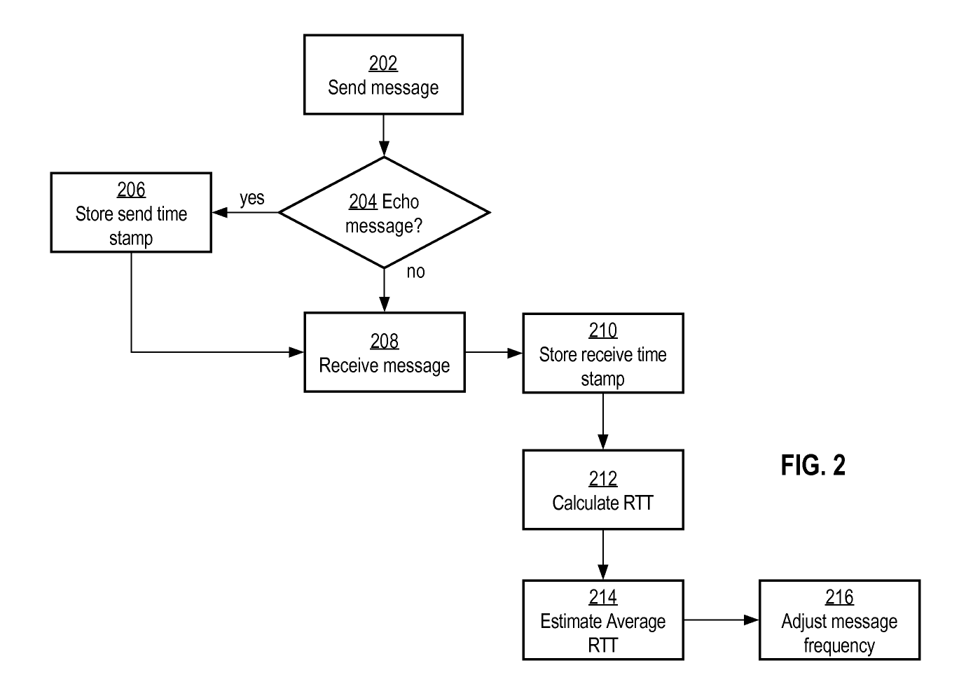

FIG. 2 illustrates an example process for congestion control for MOM. Embodiments relate to performing a congestion control process at a message producer in a client-server application system using MOM. For example, the process of FIG. 2 may be implemented in one or more of controller 124 and change detection filter 126. The controller 124 and change detection filter 126 also are examples of means for performing the functions described for FIG. 2. In an alternative, a single element of computer logic or a single computer program may implement both the controller 124 and change detection filter 126, and may comprise another means for performing the functions described for FIG. 2.

3.1 Sending Messages

In an embodiment, at step 202, one of a plurality of messages may be sent. For example, message producer 104 may place a message in token bucket 122 to be sent to MOM broker 106. Alternatively, controller 124 may place an echo message in token bucket 122. Token bucket 122 may contain a plurality of messages placed in token bucket 122 by producer 104 and controller 124 and may send each message in the plurality of messages according to a message frequency value. For example, if the message frequency value for sending messages is one message per minute, token bucket 122 may send one of the plurality of messages contained in token bucket 122 each minute.

In an embodiment, token bucket 122 may send a message to middleware API 110 which then sends the message to broker 106 to be placed on message queue 114. Thus, because controller 124 and token bucket 122 are situated before middleware API 110, the congestion control method described herein may be implemented independent of the message oriented middleware and independent of broker 106 and consumer 116, according to embodiments.

In some embodiments, step 204 determines whether a message to be sent is an echo message. For example, token bucket 122 may determine if the message to be sent in step 202 is an echo message. In some embodiments the echo message may be a particular named or marked message type used to detect congestion in the Message Oriented Middleware infrastructure. An echo message sent by producer 104 may also be consumed by producer 104 at controller 124 and may be used to determine the average round trip time of echo messages, as described below according to some embodiments.

According to an embodiment, at step 206, a timestamp may be stored representing the time that an echo message is sent. For example, token bucket 122 may determine that a message to be sent to broker 106 is an echo message at step 204. At step 206, the token bucket 122 or controller 124 may store a timestamp representing the time that token bucket 122 sent the echo message. In some embodiments, the timestamp may be stored in the echo message itself. In other embodiments, the timestamp may be stored in memory associated with producer 104 at computer 102. In some embodiments, other methods for storing the timestamp may be utilized. The particular format and storage location for the timestamp are not critical.

3.2 Determining Round Trip Time

At step 208, a message may be received, according to an embodiment. Producer 104 may be a producer of echo message 128 and also may be a consumer of echo message 128. In this example context, echo message 128, sent by producer 104, may be transmitted to message broker 106 and placed on message queue 114. Once echo message 128 moves to the front of message queue 114 through normal consumption or dequeuing of messages, producer 104 may receive and consume echo message 128 through middleware API 130 at controller 124.

In an embodiment, at step 210, the process may store a timestamp representing the time of receiving an echo message. Once echo message 128 is received at controller 124, the controller may store a timestamp representing the time that echo message 128 was received.

Controller 124 may then use the “sent” timestamp of step 206 and the “received” timestamp of step 210 to measure a round trip time (RTT) for echo message 128 at step 212. In an embodiment, the RTT may be calculated based on the difference between the “sent” timestamp and the “received” timestamp. Other calculations for determining the RTT of a message may be used. In an embodiment, the RTT may represent the amount of time it took for echo message 128 to be transmitted from producer 104 to broker 106, through message queue 114 and back to producer 104 at controller 124.

3.3 Estimating Round Trip Time

At step 214, the RTT for echo messages may be estimated, according to embodiments. In an embodiment, change detection filter 126 may estimate the average RTT of a plurality of echo messages. For example, controller 124 may place a plurality of echo messages in token bucket 122 to estimate the RTT for echo messages sent through the MOM. For example, controller 124 may place each of the plurality of echo messages into token bucket 122 according to an echo message frequency value. The echo messages may be interspersed with other messages in token bucket 122, such as message 112 from producer 104. In an embodiment, the echo message frequency value may be adjusted based on the estimated RTT, as determined at step 214.

Token bucket 122 may send each of the plurality of echo messages to MOM broker 106 through middleware API 110. The broker may send the echo message to controller 124 where the actual RTT for the echo message may be calculated, as described above in section 3.2. Controller 124 may provide the measured actual RTT of each echo message to change detection filter 126 for RTT estimation. As the actual RTT for each echo message changes, the estimate for the RTT may change. For example, when the actual RTT for each echo message increases, the estimated average RTT may increase. Likewise, when the actual RTT for each echo message decreases, the estimated average RTT may decrease. Change detection filter 126 may be, for example, one or more computer program applications, other software elements, one or more software libraries, or other functional logic for estimating the average round trip time for a plurality of echo messages.

In some embodiments, the RTT for echo messages estimated at step 214 may be used to detect congestion in the MOM. For example, if message queue 114 in broker 106 begins to saturate, then congestion may increase and the mean value of the RTT of echo messages may change. For example, a computer system hosting producer 104, broker 106, or consumer 116 may be affected by network node discovery, cable cuts, LAN disconnections, alarm storms, or other events that slow the system down or prevent consumer 116 from consuming messages placed in message queue 114. When consumer 116 cannot consume the messages in message queue 114 fast enough, the messages may remain in the queue without reaching the receiver. Therefore, when an echo message is sent to measure the RTT of messages in the system, an increased RTT may be observed. Thus, a change of the mean value of the round trip time for echo messages may be used to determine whether the MOM is congested.

In some embodiments, change detection filter 126 may distinguish between measurement noise and changes in the average RTT of echo messages so that changes in the average RTT may be detected and estimated. In an embodiment, change detection filter 126 may be a cumulative sum (CUSUM) Kalman adaptive filter that filters out measurement noise and estimates the RTT for echo messages. For example, the calculated round trip times for echo messages may vary; thus, an RTT for echo messages may be estimated to determine whether congestion exists within the MOM. However, round trip times for some echo messages should not be considered in estimating an average RTT. For example, some measured round trip times may deviate too far from the real round trip time and should be excluded from the RTT estimation as they may skew the estimated value. The measured round trip times that deviate too far from the real RTT may be considered outlier measurements, or noise. However, an outlier measurement may indicate a change in the RTT instead of being mere noise. A CUSUM Kalman filter may be used to distinguish between measurement noise and RTT calculations that should be used to determine the round trip time through the MOM. A CUSUM Kalman filter may detect the changes in the mean value of the RTT of echo messages despite the measurement noise.

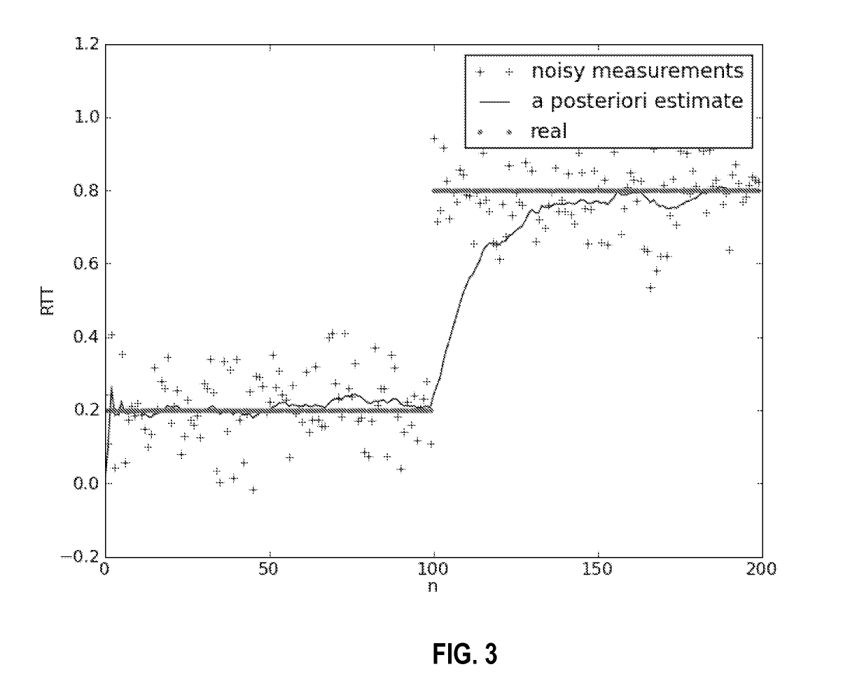

The use of the cumulative sum Kalman filter may be further illustrated with reference to the chart of FIG. 3. For example, the vertical axis of the chart indicates the round trip times for echo messages transmitted through the MOM. The horizontal axis of the chart indicates the order of messages received, e.g., message 1, message 2, to message n. Thus, the chart provides information regarding the round trip time of each message (1 to n) as it is received by the Kalman filter. Additionally, the crosses (+) on the chart show the measure of round trip times of messages as they are received. Some of the crosses may illustrate measurement noise, as discussed above. The dots, appearing as horizontal lines at RTT 0.2 and RTT 0.8, indicate the real RTT for messages within the MOM. The real RTT may be modeled as a piece-wise constant as illustrated by the piece-wise graph in FIG. 3. The continuous line in the chart represents the a posteriori RTT estimate as calculated by the cumulative sum Kalman filter. As illustrated by FIG. 3., the a posteriori RTT estimate, as estimated by the Kalman filter, closely follows the real average RTT. Thus, that the Kalman filter may allow for quick convergence to the real RTT allowing for fast estimation of the RTT despite measurement noise.

In other embodiments, other change detection filters may be used to estimate the average round trip time of echo messages. For example, an adaptive CUSUM least square [LS] or CUSUM recursive least square [RLS] filter may be used.

3.4 Adjusting Message Frequency

At step 216, the message frequency value may be adjusted, according to some embodiments. Adjustment may occur in response to a signal or message communicated from the change detection filter 126 to the controller 124, or based on the controller polling the change detection filter periodically, so that the controller receives data indicating a change in average round trip time. For example, controller 124 may adjust the frequency at which token bucket 122 sends messages to broker 106 based on the average round trip time of echo messages, as estimated by change detection filter 126, in response to receiving data from the change detection filter indicating a change in the average round trip time.

By decreasing the message frequency that token bucket 122 sends messages to broker 106 when congestion is detected, congestion within the MOM may be decreased. Thus, message producer 104 may control congestion within the MOM by utilizing token bucket 122, change detection filter 126 and controller 124.

One effect of the present approach is that messages of producer 104 are held in token bucket 122 during network congestion conditions. Consequently, operation of producer 104 may be changed or slowed if the producer cannot change state until messages are queued to the message oriented middleware broker 106. However, the present approaches recognize that holding messages of the producer 104 in the token bucket 122 is better for overall system performance than allowing the producer 104 to queue an unlimited number of messages to the broker at times of congestion. The approaches herein provide the benefit of allowing the message queue 114 to clear at times of congestion by preventing producer 104 from enqueuing messages that will continue to over-fill the queue 114 or that cannot reach or be consumed by consumer 116.

The approaches herein might be optimized by structuring the substantive operational logic of producer 104 to detect when messages have not left token bucket 122 or have not reached message queue 114 and to change the behavior of the producer in response to such a condition. For example, in response to such detection, in one embodiment producer 104 might create and store a log message or generate a user interface notification informing a user of the computer 102 that network delays are occurring. Additionally or alternatively, producer 104 might generate and eventually send to consumer 116 a special form of message indicating that network congestion and messaging delays have occurred. Producer 104 also could be structured to perform a certain number of retries of message queuing through the token bucket 122 and “give up” and change state after the maximum number of retries occurs.

Another effect of the present approach is that congestion may be controlled independently of the particular MOM used. Consequently, the particular MOM may be replaced by another MOM while retaining the benefit of congestion control. For example, token bucket 122, controller 124 and change detection filter 126 may be implemented between the substantive operational logic of producer 104 and middleware API 110/130. The MOM, including the middleware APIs and the middleware broker 106, may be unaware of token bucket 122, controller 124, change detection filter 126, and echo message 128. Thus, the MOM APIs and MOM broker may be replaced by another MOM implementation without affecting token bucket 122, controller 124 and change detection filter 126.

4.0 Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

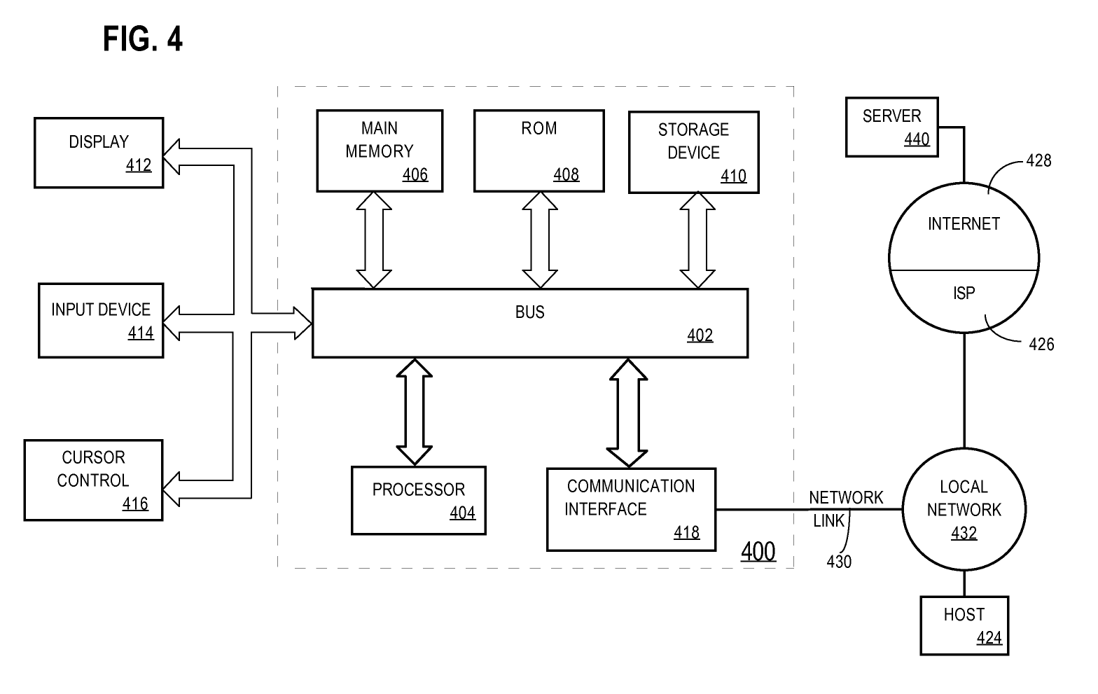

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

5.0 Extensions and Alternatives

In the foregoing specification, embodiments of the invention have been described with reference to numerous specific details that may vary from implementation to implementation. The specification and drawings are, accordingly, to be regarded in an illustrative rather than a restrictive sense.

What is claimed is:

1. A computer-implemented method comprising:
sending a first plurality of messages to a message oriented middleware (MOM) broker according to a message frequency value;
obtaining a first message from the MOM broker, the first message comprising one message among the first plurality of messages;
determining an estimated round trip time for communicating the first message from a message producer to the MOM broker and back to the producer;
adjusting the message frequency value based on the estimated round trip time;
wherein the method is performed by one or more processors.

2. The computer-implemented method of claim 1, further comprising:
storing a first timestamp representing a time that a message is sent to the MOM broker;
storing a second timestamp representing a time that the message is received from the MOM broker; and
determining a round trip time based on the first timestamp and the second timestamp.

3. The computer-implemented method of claim 1, wherein determining the round trip time for the second plurality of messages includes estimating the round trip time with a change detection filter.

4. The computer-implemented method of claim 3, wherein the change detection filter is a CUSUM Kalman adaptive filter.

5. The computer-implemented method of claim 1, wherein the MOM broker is a message queuing middleware broker.

6. The computer-implemented method of claim 1, wherein the MOM broker is a CORBA message oriented middleware broker.

7. The computer-implemented method of claim 1, wherein the messages are application level messages.

8. A machine-readable storage medium storing one or more sequences of instructions, when executed by one or more processors, causes performing:
sending a first plurality of messages to a message oriented middleware (MOM) broker according to a message frequency value;
obtaining a first message from the MOM broker, the first message comprising one message among the first plurality of messages;
determining an estimated round trip time for communicating the first message from a message producer to the MOM broker and back to the producer;
adjusting the message frequency value based on the estimated round trip time.

9. The machine-readable storage medium of claim 8, further comprising one or more sequences of instructions, when executed by one or more processors, causes performing:
storing a first timestamp representing a time that a message is sent to the MOM broker;
storing a second timestamp representing a time that the message is received from the MOM broker; and
determining a round trip time based on the first timestamp and the second timestamp.

10. The machine-readable storage medium of claim 8, wherein determining the average round trip time for the second plurality of messages includes estimating the average round trip time with a change detection filter.

11. The machine-readable storage medium of claim 10, wherein the change detection filter is a CUSUM Kalman adaptive filter.

12. The machine-readable storage medium of claim 8, wherein the MOM broker is a message queuing middleware broker.

13. The machine-readable storage medium of claim 8, wherein the is a CORBA message oriented middleware broker.

14. The machine-readable storage medium of claim 8, wherein the messages are application level messages.

15. An apparatus comprising:
one or more processors;
a token bucket configured to send a first plurality of messages to a message oriented middleware (MOM) broker according to a message frequency value;
a controller configured to receive a first message from the MOM broker, the first message comprising one message among the first plurality of messages;
a change detection filter configured to determine, using the one or more processors, an average round trip time for communicating the first message from a message producer to the MOM broker and back to the producer; and
wherein the controller adjusts the message frequency value based on the average round trip time.

16. The apparatus of claim 15, wherein the token bucket stores a first timestamp representing a time that a message is sent to the MOM broker; and wherein the controller stores a second timestamp representing a time that the message is received from the MOM broker and determines a round trip time based on the first timestamp and the second timestamp.

17. The apparatus of claim 15, wherein determining the round trip time for the first message includes estimating the round trip time with a change detection filter.

18. The apparatus of claim 17, wherein the change detection filter is a CUSUM Kalman adaptive filter.

19. The apparatus of claim 15, wherein the MOM broker is a message queuing middleware broker.

21. The apparatus of claim 15, wherein the is a CORBA message oriented middleware broker.

22. The apparatus of claim 15, wherein the messages are application level messages.

23. A computer-implemented method comprising:
sending a first plurality of messages to a message oriented middleware broker according to a message frequency value;
receiving a second plurality of messages from the broker, the second plurality of messages comprising a subset of the first plurality of messages;
determining a round trip time estimation for communicating the second plurality of messages from a message producer to the broker and back to the producer,
wherein determining the round trip time for the second plurality of messages includes estimating the round trip time with a CUSUM Kalman change detection filter;
adjusting the message frequency value based on the round trip time estimation;
wherein the method is performed by one or more processors.

24. The computer-implemented method of claim 23, wherein the broker is a message queuing middleware broker.

25. A machine-readable storage medium storing one or more sequences of instructions, when executed by one or more processors, causes performing:
sending a first plurality of messages to a message oriented middleware broker according to a message frequency value;
receiving a second plurality of messages from the broker, the second plurality of messages comprising a subset of the first plurality of messages;
determining a round trip time estimation for communicating the second plurality of messages from a message producer to the broker and back to the producer,
wherein determining the round trip time estimation for the second plurality of messages includes estimating the round trip time with a CUSUM Kalman change detection filter; and
adjusting the message frequency value based on the round trip time estimation.
